(19) United States
(12) Patent Application Publication
(10) Pub. No.: US 2010/0042695 A1
(43) Pub. Date: Feb. 18, 2010

(54) MESSAGE PLAYBACK APPARATUS

(75) Inventors: Jung-Ying Yao, Taoyuan (TW); Yu-Hua Kan, Taoyuan (TW); Jung-Chi Lai, Taoyuan (TW); Chin-Jung Su, Taoyuan (TW); Chien-Hsin Lee, Taoyuan (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: Darfon Electronics Corp., Taoyuan (TW)

(21) Appl. No.: 12/540,812

(22) Filed: Aug. 13, 2009

(30) Foreign Application Priority Data
Aug. 14, 2008 (TW) 097214577

(51) Int. Cl. G06F 15/16

(52) U.S. Cl. 709/206

(57) ABSTRACT

The invention discloses a message playback apparatus. The message playback apparatus includes a receiving module, an analysis module, a storage module, and an output module. The receiving module is used for receiving a plurality of external messages. The analysis module is used for selecting at least one target message from the external messages. The storage module is used for storing the at least one target message. The output module is used for reading out the at least one target message and transforming the at least one target message to an output signal.

### BACKGROUND OF THE INVENTION

1. Field of the invention

The invention relates to a message playback apparatus, and more particularly, to a message playback apparatus capable of receiving external messages from the internet and transforming a target message selected from the external messages to an output message.

2. Description of the prior art

Recently, applications related to the digital home are rapidly developed by many information and electronic appliance companies. The core of the digital home is to form a home networking structure by connecting all of the information, communication, and consumer electronic equipments in home via a wire or wireless network technology. And, the home network can be integrated with an external network system via a specific home gateway to realize the vision of e-life in the future.

The novel digital home appliances with network functions, such as a digital set-top box, a portable media player, a DVD player, a digital media center, a game machine, and MP3 player, have been provided in the market. With these digital home appliances, users can access the digital media content at any place in home, such as the living room, the kitchen, or the bedroom.

In general, a media playback apparatus can provide the most directional interface between human and electronic information products, namely, the media playback apparatus can be used as an output apparatus for showing an image and text signal. Until now, the television is one of the most used media playback apparatus in ordinary families, especially in this information explosion era. With the development of technologies, the user can see scenic places all over the world, famous opera performances, or exciting ball games via the playback function of television in his/her home. No matter watching or listening, the user can feel the visual or hearing telepresence, so that the user can be satisfied in sensory when he/she watches the television.

Additionally, “information feed” has become a very popular information processing type currently. Usually, the information feed can be explained as a technology of periodically updating the user-interested information items (e.g., the news) to an electronic apparatus. For example, the RSS and ATOM technologies can allow the user to subscribe the information feed available in the internet. Once the information feed is subscribed, the user can see the information items available on the specific information feed. Usually, these information items can also provide internet pages or other sources related to the detail of the information items to the user to access.

However, the current playback apparatus lacks of functions of internet interface, therefore, the user can not use the playback apparatus to download a media file, listen a song on line, watch a movie on line, or browse pages via internet When the user wants to perform the operations of update songs, watch movies, or browse pages, the user should perform the operations via a computer or other internet reachable electronic apparatus and save the files in its storage unit. And then, the playback apparatus can obtain the files from the computer or other internet reachable electronic apparatus via its USB port, and playback or display the files according to user's operations.

In view of this, the main scope of the invention is to provide a message playback apparatus capable of accessing the external information by connecting to the internet, and classifying the processed information to the default terms according to the filtering process predetermined by the user. And, in the hardware configuration, several display buttons can be provided to remind the user that there are still some terms not processed. By doing so, after the user performs command through touching or voice, the information can be transformed to the form of sound to the user.

### SUMMARY OF THE INVENTION

A scope of the invention is to provide a message playback apparatus. The message playback apparatus includes a receiving module, an analysis module, a storage module, and an output module. The receiving module is electrically connected to an internet, and used for receiving a plurality of external messages from the internet The analysis module is electrically connected to the receiving module, and used for analyzing the plurality of external messages and selecting at least one target message from the plurality of external messages. The storage module is electrically connected to the analysis module, and used for storing the at least one target message selected by the analysis module. The output module is electrically connected to the storage module, and used for reading out the at least one target message and transforming the at least one target message to an output signal.

Therefore, the message playback apparatus according to the invention can access the external information by connecting to the internet, and classify the processed information to the default terms according to the filtering process predetermined by the user. And, in the hardware configuration, several display buttons can be provided to remind the user that there are still some terms not processed. By doing so, after the user performs command through touching or voice, the information can be transformed to the form of sound to the user.

The objective of the present invention will no doubt become obvious to those of ordinary skill in the art after reading the following detailed description of the preferred embodiment, which is illustrated in the various figures and drawings.

### BRIEF DESCRIPTION OF THE APPENDED DRAWINGS

FIG. 1A illustrates the block function diagram of the message playback apparatus in the first embodiment of the invention.

FIG. 1B illustrates the block function diagram of the message playback apparatus in the second embodiment of the invention.

FIG. 1C illustrates the block function diagram of the message playback apparatus in the third embodiment of the invention.

FIG. 1D illustrates the block function diagram of the message playback apparatus in the fourth embodiment of the invention.

### DETAILED DESCRIPTION OF THE INVENTION

The invention provides a message playback apparatus. And, more particularly, the message playback apparatus can access the external information by connecting to the internet, and classify the processed information to the default terms according to the filtering process predetermined by the user. By doing so, after the user performs command through touching or voice, the information can be transformed to the form of sound to the user. The following will show the detailed description of the preferred embodiment of the invention to fully explain the characteristic, spirit, advantage, and convenience in practice.

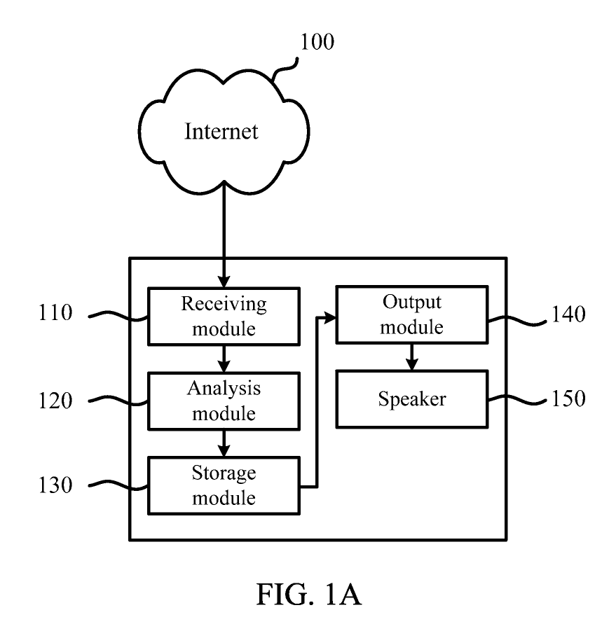

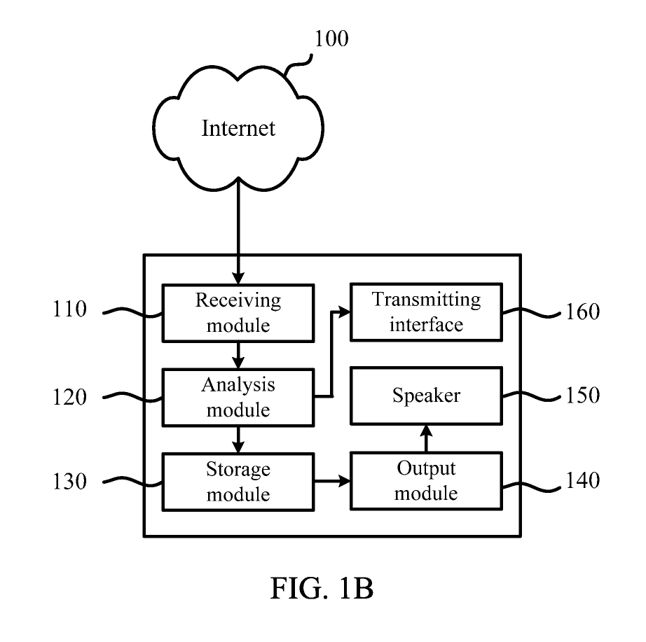

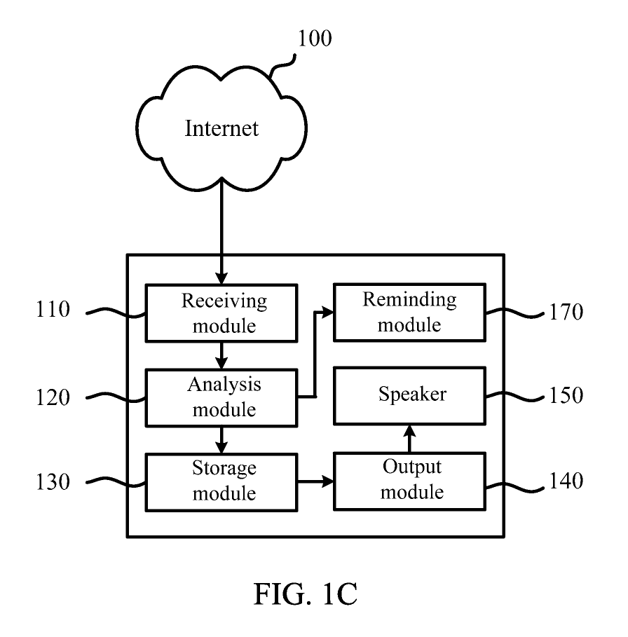

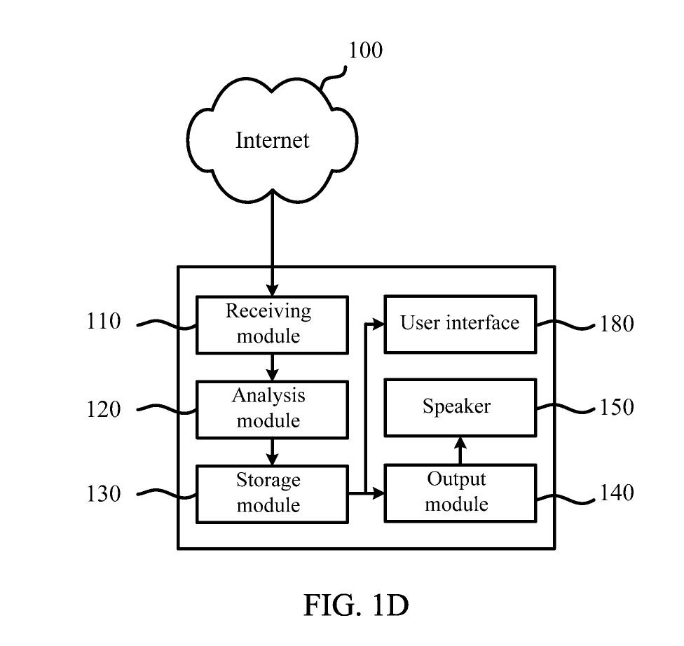

Please refer to FIG. 1A. FIG. 1A illustrates the block function diagram of the message playback apparatus in the first embodiment of the invention. As shown in FIG. 1A, the message playback apparatus includes a receiving module 110, an analysis module 120, a storage module 130, and an output module 140. The following shows the detail of the message playback apparatus in the embodiment of the invention including the structure and functions of the modules in the message playback apparatus.

As shown in FIG. 1A, the receiving module 110 is electrically connected to an internet 100, and used for receiving a plurality of external messages from the internet 100 according to a preset condition. The analysis module 120 is electrically connected to the receiving module 110. The analysis module 120 can be used for analyzing the plurality of external messages and selecting at least one target message from the plurality of external messages. The storage module 130 is electrically connected to the analysis module 120. After the analysis module 120 selects the at least one target message, the at least one target message will be stored in the storage module 130. The output module 140 is electrically connected to the storage module 130. The output module 140 can be used for reading out the at least one target message from the storage module 130 and transforming the at least one target message to an output signal. In order to realize the function of receiving the plurality of external messages, in this embodiment, the receiving module 110 includes a wireless communication unit.

Additionally, the plurality of external messages can comprise a plurality of pages on internet And, the at least one target message can be an email, a real-time communication message, a news message, or a really simple syndication (RSS).

In an embodiment, the above-mentioned storage module 130 can comprise a plurality of storage units (not shown in the figures). The analysis module 120 can select a target storage unit for storing the at least one target message from the plurality of storage units according to a message type of the at least one target message.

Please refer to FIG. 1B. FIG. 1B illustrates the block function diagram of the message playback apparatus in the second embodiment of the invention. As shown in FIG. 1B, the message playback apparatus of this embodiment of the invention can further includes a transmitting interface 160. The transmitting interface 160 is electrically connected to the analysis module 120. A user can user an external electronic device to generate or adjust the preset condition. And then, the transmitting interface 160 can transmit the preset condition from the external electronic device to the analysis module 120.

Please refer to FIG. 1C. FIG. 1C illustrates the block function diagram of the message playback apparatus in the third embodiment of the invention. As shown in FIG. IC, the message playback apparatus of this embodiment of the invention can further includes a reminding module 170. The reminding module 170 is electrically connected to the analysis module 120. After the analysis module 120 stores the at least one target message to the storage module 130, the reminding module 170 will show a reminding signal corresponding to the at least one target message to inform a user the existence of the at least one target message.

Please refer to FIG. 1D. FIG. 1D illustrates the block function diagram of the message playback apparatus in the fourth embodiment of the invention. As shown in FIG. ID, the message playback apparatus of this embodiment of the invention can further includes a user interface 180. The user interface 180 is electrically connected to the output module 140. A user can generate a user request to the output module 140 via the user interface 180.

And, the message playback apparatus of this embodiment of the invention can further includes a display (not shown in the figures). The display is electrically connected to the output module 140. The display is used for playbacking the output signal according to the user request generated by the user interface 180.

In addition, the message playback apparatus of this embodiment of the invention can further includes a speaker (not shown in the figures). The speaker is electrically connected to the output module 140. The speaker can be also used for playbacking the output signal according to the user request generated by the user interface 180.

For example, the above-mentioned user interface 180 can further include a voice-operated component or a button (not shown in the figures). With that, the user can generate the above-mentioned user request by operating the voice-operated component or the button on the user interface 180 of the message playback apparatus in this invention.

Therefore, in an embodiment, the above-mentioned reminding signal can be a light signal, and the reminding module 170 can include a light bulb. In another embodiment, the above-mentioned reminding signal can be also a sound signal and the speaker 150 can be also used to playback the reminding signal, but not limited to this. For example, the above-mentioned reminding signal can be also a vibration signal, and the reminding module 170 can include a vibration unit. With this, the message playback apparatus of the invention can effectively inform the user that there are still messages waiting for the user to select to playback.

To sum up, it can be obviously found that the message playback apparatus of the invention can access the external information by connecting to the internet, and classify the processed information to the default terms according to the filtering process predetermined by the user. And, in the hardware configuration, several display buttons can be provided to remind the user that there are still some terms not processed. By doing so, after the user performs command through touching or voice, the information can be transformed to the form of sound to the user.

Although the present invention has been illustrated and described with reference to the preferred embodiment thereof, it should be understood that it is in no way limited to the details of such embodiment but is capable of numerous modifications within the scope of the appended claims.

What is claimed is:

1. A message playback apparatus, comprising:
a receiving module, electrically connected to an internet, for receiving a plurality of external messages from the internet according to a preset condition;
an analysis module, electrically connected to the receiving module, for analyzing the plurality of external messages and selecting at least one target message from the plurality of external messages;
a storage module, electrically connected to the analysis module, for storing the at least one target message selected by the analysis module; and
an output module, electrically connected to the storage module, for reading out the at least one target message from the storage module and transforming the at least one target message to an output signal.

2. The message playback apparatus of claim 1, further comprising:
a user interface, electrically connected to the output module, for generating a user request to the output module by a user.

3. The message playback apparatus of claim 2, further comprising:
a display, electrically connected to the output module, for playbacking the output signal according to the user request.

4. The message playback apparatus of claim 2, further comprising:
a speaker, electrically connected to the output module, for playbacking the output signal according to the user request.

5. The message playback apparatus of claim 2, wherein the user interface can further comprise a voice-operated component or a button.

6. The message playback apparatus of claim 1, wherein the receiving module comprises a wireless communication unit.

7. The message playback apparatus of claim 1, wherein the at least one target message is an email, a real-time communication message, a news message, or a really simple syndication (RSS).

8. The message playback apparatus of claim 1, wherein the plurality of external messages comprises a plurality of pages on internet.

9. The message playback apparatus of claim 1, further comprising:
a transmitting interface, electrically connected to the analysis module, a user can user an external electronic device to generate or adjust the preset condition, and then the transmitting interface can transmit the preset condition from the external electronic device to the analysis module.

10. The message playback apparatus of claim 1, further comprising:
a reminding module, electrically connected to the analysis module, for showing a reminding signal corresponding to the at least one target message to inform a user the existence of the at least one target message after the analysis module stores the at least one target message to the storage module.

11. The message playback apparatus of claim 10, wherein the reminding signal is a light signal and the reminding module comprises a light bulb.

12. The message playback apparatus of claim 10, wherein the reminding signal is a sound signal and the speaker is also used to playback the reminding signal.

13. The message playback apparatus of claim 1, wherein the storage module comprises a plurality of storage units, the analysis module selects a target storage unit for storing the at least one target message from the plurality of storage units according to a message type of the at least one target message.
